(19) United States
(12) Patent Application Publication
(10) Pub. No.: US 2025/0388142 A1
(43) Pub. Date: Dec. 25, 2025

(54) SEAT FRAME AND BACK FRAME

(71) Applicant: TOYOTA BOSHOKU KABUSHIKI KAISHA, Aichi (JP)

(72) Inventors: Yuya AKAI, Miyoshi-shi (JP); Kazuma OHARA, Seto-shi (JP)

(73) Assignee: TOYOTA BOSHOKU KABUSHIKI KAISHA, Aichi (JP)

(21) Appl. No.: 19/240,576

(22) Filed: Jun. 17, 2025

(30) Foreign Application Priority Data
Jun. 21, 2024 (JP) 2024-100259

(51) Int. Cl. B60N 2/68

(52) U.S. Cl. CPC B60N 2/68

(57) ABSTRACT

To provide a seat frame and a back frame of a vehicle seat. The seat frame of the present disclosure includes a first frame and a second frame. A wrap portion is provided outside a portion of the first frame corresponding to an end portion of the second frame, and when a virtual plane in contact with a wall portion continuous from the end portion of the second frame is defined as a projection plane, the wrap portion projected on the projection plane overlaps the end portion of the second frame and a part of the wall portion projected on the projection plane.

### CROSS-REFERENCE TO RELATED APPLICATIONS

The present application claims priority based on Japanese Patent Application No. 2024-100259 filed to Japanese Patent Office on Jun. 21, 2024, and the content of Japanese Patent Application No. 2024-100259 is incorporated by reference in its entirety.

### BACKGROUND

The present disclosure relates to a seat frame and a back frame of a vehicle seat.

For example, in the back frame described in Japanese Unexamined Patent Application Publication No. 2022-167380, a side frame and an upper frame are joined to constitute a part of the back frame. The side frame is a frame extending in a vertical direction. The upper frame is a frame whose one end side is connected to the upper end side of the side frame and extending in a seat width direction.

### SUMMARY

In the invention described in Japanese Unexamined Patent Application Publication No. 2022-167380, the terminal of the side frame and the terminal of the upper frame face each other with a predetermined gap interposed therebetween so as to oppose each other. In order to prevent at least one of the terminal of the side frame and the terminal of the upper frame from coming into contact with another object, in the invention described in Japanese Unexamined Patent Application Publication No. 2022-167380, the dimensional variations of the individual frames are strictly managed such that the dimension of the gap falls within an appropriate range.

In view of the above points, the present disclosure discloses an example of a seat frame and a back frame capable of preventing a terminal of a frame from coming into contact with another object even in a case where the management of dimensional variations is relaxed.

A seat frame including a first frame and a second frame constituting the framework of a vehicle seat and in which the first frame and the second frame are joined to each other desirably includes, for example, at least one of the following components.

The components are that a wrap portion is provided outside a portion of the first frame corresponding to an end portion of the second frame, and when a virtual plane in contact with a wall portion continuous from the end portion is defined as a projection plane, the wrap portion projected on the projection plane overlaps the end portion and a part of the wall portion projected on the projection plane.

As a result, in the seat frame, it is possible to prevent at least the terminal of the second frame from coming into contact with another object even in a case where the dimension of the gap between the end portion of the first frame and the end portion of the second frame varies.

A back frame of a vehicle seat includes a first side frame extending in a vertical direction, a second side frame disposed at a position shifted from the first side frame in a seat width direction, the second side frame extending in the vertical direction, an upper frame extending in the seat width direction and connecting an upper end side of the first side frame and an upper end side of the second side frame, and a lower frame extending in the seat width direction and connecting a lower end side of the first side frame and a lower end side of the second side frame. A wrap portion is provided outside a portion of the first side frame corresponding to an end portion of the upper frame, and when a virtual plane in contact with a wall portion continuous from the end portion is defined as a projection plane, the wrap portion projected on the projection plane desirably overlaps the end portion and a part of the wall portion projected on the projection plane.

As a result, in the back frame, it is possible to prevent at least the terminal of the upper frame from coming into contact with another object even in a case where the dimension of the gap between the end portion of the first side frame and the end portion of the upper frame varies.

The back frame may have the following configuration.

The back frame includes a flange portion that constitutes an upper end of the upper frame, having a portion substantially parallel to a seat longitudinal direction, and having the end portion of the upper frame and the wall portion. The wall portion is desirably inclined to become lower toward the end portion.

As a result, it is possible to prevent the terminal of the upper frame from coming into another object and the terminal of the first side frame from coming into contact with another object.

Desirably, a wall-like portion continuous from an end portion of the wrap portion is substantially parallel to the seat width direction or is inclined to become lower toward the end portion of the wrap portion.

As a result, it is possible to reliably prevent the terminal of the upper frame from coming into another object and the terminal of the first side frame from coming into contact with another object. “The portion is substantially parallel to the seat width direction” refers to a state where the elevation angle of the portion is, for example, equal to or less than 30 degrees.

The wrap portion is desirably formed in a bag shape including a first wall portion located on a front side, a second wall portion located on a rear side, and a third wall portion having a surface opposing the projection plane.

In the back frame, the joint portion of the second side frame and the upper frame may have the same configuration as the joint portion of the first side frame and the upper frame.

### BRIEF DESCRIPTION OF THE DRAWINGS

An example embodiment of the present disclosure will be described below with reference to the accompanying drawings, in which:

FIG. 1 is a diagram illustrating a back frame according to a first embodiment;

FIG. 2 is a diagram illustrating a structure of a joint portion of a first side frame and an upper frame;

FIG. 3 is a diagram illustrating the structure of the joint portion of the first side frame and the upper frame;

FIG. 4 is a diagram illustrating the structure of the joint portion of the first side frame and the upper frame; and

FIG. 5 is a diagram illustrating the structure of the joint portion of the first side frame and the upper frame.

### DETAILED DESCRIPTION OF EXEMPLARY EMBODIMENTS

The following embodiments of the present invention illustrate examples of embodiments falling within the technical scope of the present disclosure. That is, the matters specifying the invention and the like described in the claims are not limited to the specific configurations, structures and the like described in the following embodiments.

The present embodiment is an example of a back frame of a seat (hereinafter, referred to as vehicle seat) mounted on a vehicle such as an automobile. Arrows indicating directions, oblique lines, and the like attached to the individual drawings are described in order to facilitate understanding of the relationship between the individual drawings, the shape of members or portions, and the like.

The back frame is not limited to the directions illustrated in the drawings. The directions illustrated in the individual drawings are directions in a state where the vehicle seat is assembled to a vehicle. The view with oblique lines does not necessarily show a cross-sectional view.

At least one member or portion described with at least a reference sign is provided unless otherwise noted such as “only one”. That is, when there is no description such as “only one”, two or more members may be provided. The back frame disclosed in the present disclosure includes at least one of components such as members or portions described with at least reference signs and structural portions shown in the drawings.

### First Embodiment

### <1. Outline of Back Frame>

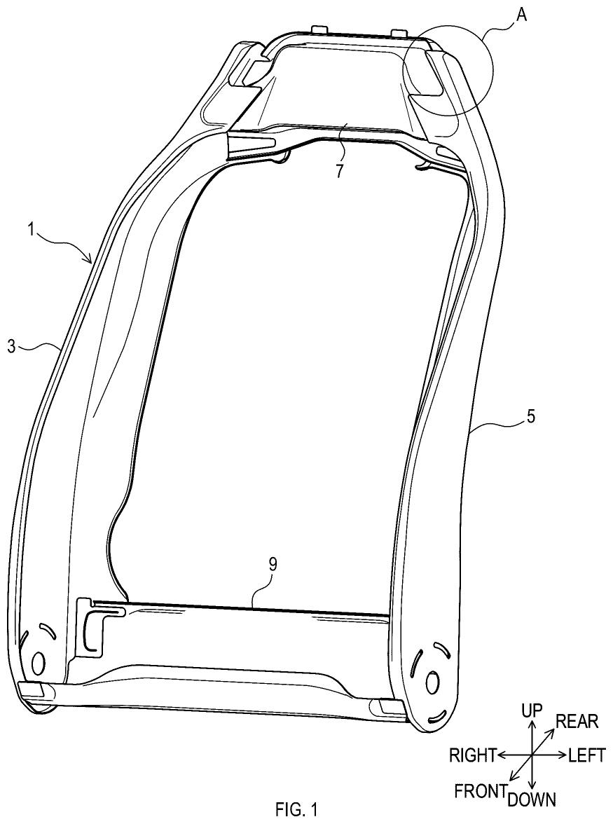

As illustrated in FIG. 1, a back frame 1 is an example of a substantially rectangular frame-shaped seat frame constituting the framework of a seat back. The seat back supports the back of a sitter. The back frame 1 is rotatably coupled to the rear end side of a cushion frame (not illustrated).

The back frame 1 includes a first side frame 3, a second side frame 5, an upper frame 7, and a lower frame 9. The first side frame 3 and the second side frame 5 are strength members extending substantially in the vertical direction.

The second side frame 5 is disposed at a position shifted from the first side frame 3 in a seat width direction (in FIG. 1, to the left side). The upper frame 7 is a strength member extending in the seat width direction and connecting the upper end side of the first side frame 3 and the upper end side of the second side frame 5.

The lower frame 9 is a strength member extending in the seat width direction and connecting the lower end side of the first side frame 3 and the lower end side of the second side frame 5. The first side frame 3, the second side frame 5, the upper frame 7, and the lower frame 9 are made of metal, and the frames are joined by laser welding.

### <2. Structure of Joint Portion of Side Frame and Upper Frame>

The back frame 1 has a substantially bilaterally symmetrical structure. The following description relates to a joint structure (part A in FIG. 1) of the first side frame 3 and the upper frame 7.

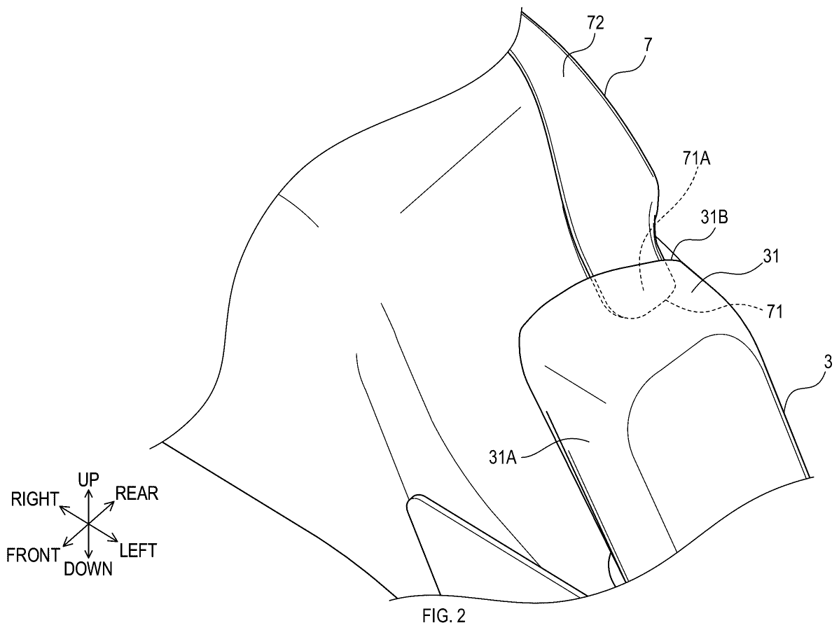

As illustrated in FIG. 2, a wrap portion 31 is provided outside a portion of the first side frame 3 corresponding to an end portion 71 of the upper frame 7. “End portion 71” is an end portion (in the present embodiment, the left end) of a flange portion 72 in the seat width direction.

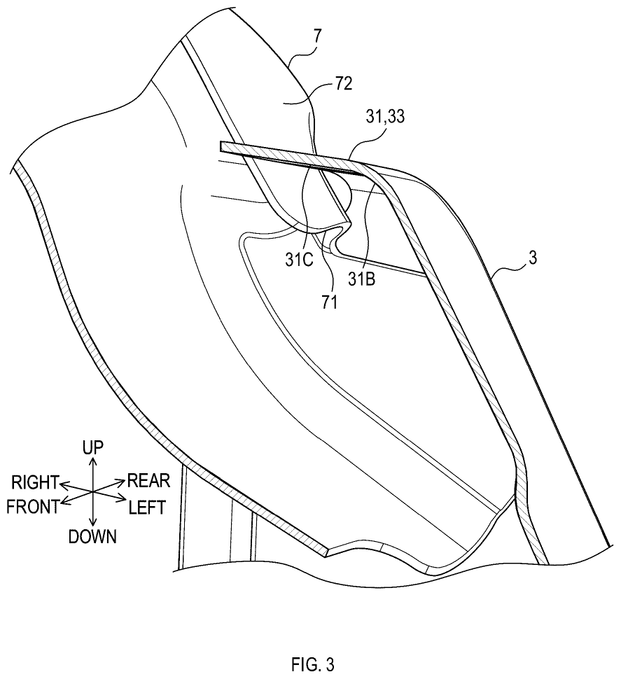

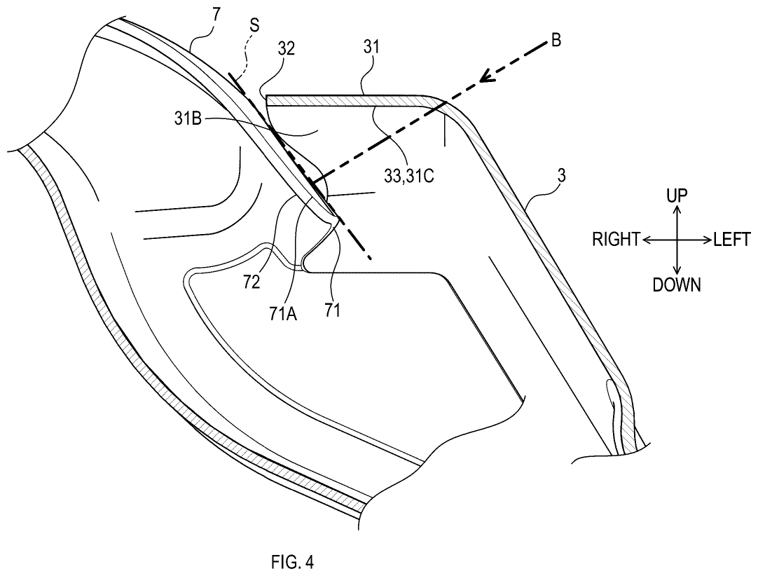

The flange portion 72 is, for example, a wall-like portion (see FIG. 4) that constitutes the upper end of the upper frame 7 (see FIG. 3) and is substantially parallel to the seat longitudinal direction, and is a portion extending to the front side from the rear end side of the upper frame 7.

“Outside” in “outside the portion of the first side frame corresponding to the end portion 71” refers to the side opposite to “inside” with the inner edge portion of the back frame 1 interposed therebetween. “Inside” refers to the side opposite to the space surrounded by the back frame 1.

As illustrated in FIG. 4, assuming that a virtual plane in contact with a wall portion 71A continuous from the end portion 71 is defined as a projection plane S, the wrap portion 31 projected on the projection plane S overlaps the end portion 71 and a part of the wall portion 71A projected on the projection plane S as illustrated in FIG. 2.

That is, when an observer observes the part A in FIG. 1 from an arrow B illustrated in FIG. 4, as illustrated in FIG. 2, it seems to the observer that the wrap portion 31 is located on the near side, and the end portion 71 and a part of the wall portion 71A overlap the wrap portion 31.

The wall portion 71A, that is, the projection plane S is inclined to be lower toward the end portion 71, and the wall-like portion 33 continuous from the end portion 32 of the wrap portion 31 is substantially parallel to the seat width direction or is inclined to become lower toward the end portion 32. “The portion 33 is substantially parallel to the seat width direction” refers to a state where the elevation angle of the portion 33 is, for example, equal to or less than 30 degrees.

In other words, the wrap portion 31 overlaps the end portion 71 and a part of the wall portion 71A so as to cover the end portion 71 and a part of the wall portion 71A from outside, and the wall portion 71A extends downward on the left end side so as to go under the wrap portion 31.

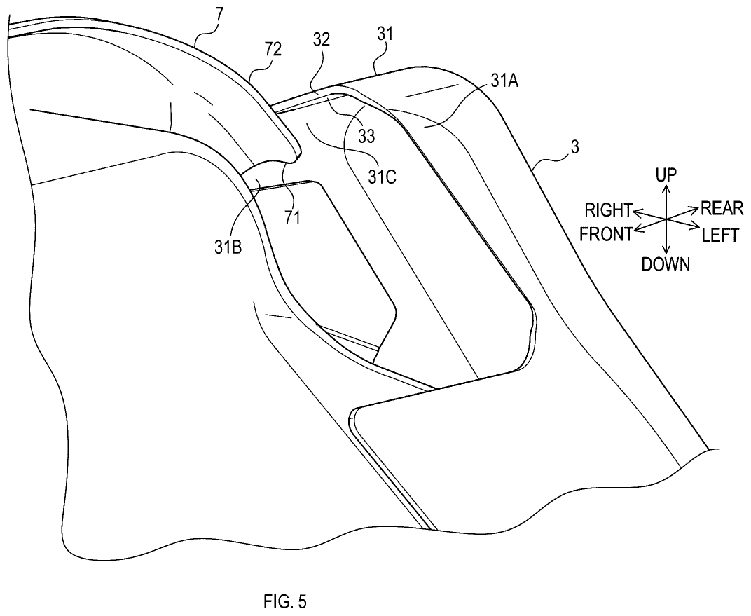

As illustrated in FIG. 5, the wrap portion 31 has a first wall portion 31A, a second wall portion 31B, and a third wall portion 31C and is formed in a bag shape. The first wall portion 31A is located on the front side of the flange portion 72.

The second wall portion 31B is located on the rear side of the flange portion 72. The third wall portion 31C has a surface opposing the projection plane S. The third wall portion 31C is inclined in the same direction as the wall portion 71A.

### <3. Characteristics of Back Frame>

The wrap portion 31 is provided outside the portion of the first side frame 3 corresponding to the end portion 71 of the upper frame 7, and the wrap portion 31 projected on the projection plane S overlaps the end portion 71 and a part of the wall portion 71A projected on the projection plane S (see FIG. 4).

As a result, in the back frame 1, it is possible to prevent at least the terminal of the upper frame 7 from coming into contact with another object even in a case where the dimension of the gap between the end portion 32 of the first side frame 3 and the end portion 71 of the upper frame 7 varies.

The wall portion 71A is inclined to be lower toward the end portion 71, and the wall-like portion 33 continuous from the end portion 32 of the wrap portion 31 is substantially parallel to the seat width direction or is inclined to become lower toward the end portion 32 of the wrap portion 31 (see FIG. 4).

As a result, it is possible to prevent the terminal of the upper frame 7 from coming into another object and the terminal of the first side frame 3 from coming into contact with another object.

### Other Embodiments

In the embodiment described above, the present disclosure is applied to the joint structure of the first side frame 3 and the upper frame 7 with the first side frame 3 as the first frame and the upper frame 7 as the second frame. However, the present disclosure is not limited thereto. The disclosure is also applicable to other joint structures.

In the embodiment described above, the first side frame 3 includes the wrap portion 31. However, the present disclosure is not limited thereto. The upper frame 7 may include the wrap portion 31, that is, the end portion of the upper frame 7 in the width direction may be located outside the first side frame 3.

In the embodiment described above, the vehicle seat according to the present disclosure is applied to a vehicle. However, the application of the invention disclosed herein is not limited thereto. For example, the present invention can also be applied to seats used for vehicles such as railway vehicles, ships, and aircrafts, and stationary seats used in theaters, homes, and the like.

Furthermore, the present disclosure is not limited to the embodiments described above as long as it meets the gist of the disclosure described in the embodiments. Therefore, a configuration in which at least two of the plurality of embodiments described above are combined, or a configuration in which any of the components illustrated in the drawings or the components described with reference signs in the embodiments is eliminated may be used.

What is claimed is:

1. A seat frame of a vehicle seat, comprising a first frame and a second frame, wherein
the first frame and the second frame are joined,
a wrap portion is provided outside a portion of the first frame corresponding to an end portion of the second frame, and
when a virtual plane in contact with a wall portion continuous from the end portion is defined as a projection plane,
the wrap portion projected on the projection plane overlaps the end portion and a part of the wall portion projected on the projection plane.

2. A back frame of a vehicle seat comprising:
a first side frame extending in a vertical direction;
a second side frame disposed at a position shifted from the first side frame in a seat width direction, the second side frame extending in the vertical direction;
an upper frame extending in the seat width direction and connecting an upper end side of the first side frame and an upper end side of the second side frame; and
a lower frame extending in the seat width direction and connecting a lower end side of the first side frame and a lower end side of the second side frame, wherein
a wrap portion is provided outside a portion of the first side frame corresponding to an end portion of the upper frame, and
when a virtual plane in contact with a wall portion continuous from the end portion is defined as a projection plane,
the wrap portion projected on the projection plane overlaps the end portion and a part of the wall portion projected on the projection plane.

3. The back frame according to claim 2 further comprising a flange portion that constitutes an upper end of the upper frame, having a portion substantially parallel to a seat longitudinal direction, and having the end portion, wherein
the wall portion is inclined to become lower toward the end portion.

4. The back frame according to claim 3, wherein a wall-like portion continuous from an end portion of the wrap portion is substantially parallel to the seat width direction or is inclined to become lower toward the end portion of the wrap portion.

5. The back frame according to claim 4, wherein the wrap portion is formed in a bag shape including a first wall portion located on a front side, a second wall portion located on a rear side, and a third wall portion having a surface opposing the projection plane.
